(19) United States
(12) Patent Application Publication
(10) Pub. No.: US 2015/0036149 A1
(43) Pub. Date: Feb. 5, 2015

(54) SYSTEM FOR CONTROLLING AN OPTICAL SURFACE TO BE MEASURED

(71) Applicant: THALES, Neuilly Sur Seine (FR)

(72) Inventor: Julien Fouraz, Aix-en-Provence (FR)

(21) Appl. No.: 14/448,251

(22) Filed: Jul. 31, 2014

(30) Foreign Application Priority Data
Aug. 1, 2013 (FR) FR1301855

(51) Int. Cl. G01B 9/02

(52) U.S. Cl. CPC G01B 9/02055
USPC 356/517

(57) ABSTRACT

A system (10) for controlling an optical surface to be measured relatively to an optical reference surface, the control system (10) including a first optical element (36) provided with a first optical axis and able to introduce a first phase function into the phase of an incident beam, and a second optical element (38) provided with a second optical axis and able to introduce a second phase function into the phase of a beam transmitted through or reflected by the first optical element (36). The first phase function and the second phase function each correspond to the same optical aberration and at least one from among the first optical element (36) and the second optical element (38) is rotary around the optical axis specific to the relevant optical element (36, 38).

This claims the benefit of French Patent Application FR 1301855, filed Aug. 1, 2013 and hereby incorporated by reference herein.

The present invention relates to a system for controlling an optical surface to be measured.

### BACKGROUND

Within the scope of astronomy, it is desirable to control the optical elements occurring in the complete optical combination of the telescope. This is notably the case of Earth-borne telescopes comprising, inter alia, a primary mirror and a secondary mirror. For larger telescopes, the primary mirror may consist of several hundred units called segments and which may be represented by tens of different surface shapes.

Within the scope of the manufacturing of these segments and of their final control, they should be controlled over the whole of their surface to within an accuracy of the order of 10 nm RMS relatively to their theoretical surface, completely defined elsewhere. The term of RMS designates a quadratic average and is an acronym meaning “root mean square”.

The segments of a primary mirror are said to be strongly aspherical insofar that their deviation relatively to the best sphere (typically greater than about 20 μm) does not allow direct interferometric measurement at the centre of curvature of this best sphere. Further, the dimensions of the segments are relatively large since the diameter of the segment may be of the order of 1.4 m.

Controlling such segments proves to be lengthy, difficult and expensive because of these strict requirements of surface accuracy measurement. It is therefore desirable to propose a device allowing an interferometric control of the optical surfaces of segments which is easily applied and inexpensive.

Thus, in order to achieve the control of such surfaces, it is known how to achieve interferometric control with holograms generated by a computer. A hologram generated by a computer is often designated by the acronym CGH for Computer Generated Holograms.

### SUMMARY OF THE INVENTION

However, such a control involves the use of a particular hologram which adapts to the shape of each type of segment to be measured. Thus, the same number of holograms as the number of segment types to be measured has to be made and, at each change in the type of segments, the hologram used should be modified. This causes an overcost. Further, as the hologram is specific to the segment, any change in the specifications of the latter will make the hologram unsuitable.

Further, the impossibility of calibrating the measurement configuration and the measurement elements once the different elements are set into place reduces the accuracy of the measurement. A means for attenuating this problem is to perform an interferometric measurement independent of the hologram. This has a direct impact in terms of cost and time.

Further, because the holograms are diffractive optics, the application of this measurement implies the generation of a mechanical vibration of the segment or of reference optics, which is often delicate to apply.

Therefore there exists a need for a system for controlling an optical surface to be measured, based on an optical reference surface allowing accurate control of several optics of a different type while retaining a certain convenience in use.

It is an object of the present invention to provide a system for controlling an optical surface to be measured based on an optical reference surface, the control system comprising a unit for modifying the phase of an incident light beam. The unit for modifying the phase comprises a first optical element provided with a first optical axis and able to introduce a first phase function in the phase of an incident beam and a second optical element provided with a second optical axis and able to introduce a second phase function in the phase of a beam transmitted or reflected by the first optical element. The first phase function and the second phase function each correspond to the same optical aberration and at least one of the first optical element and of the second optical element is rotary around the optical axis specific to the relevant optical element.

According to particular embodiments, the optical system comprises one or several of the following features, taken individually or according to all the technically possible combinations:

the control system comprises a device for producing interferences between a first light beam and a second light beam, the first beam having a phase proportional to the deviation between the reference optical surface and an ideal planar surface and the second beam having a phase equal to the sum of a phase proportional to deviation between the optical surface to be measured and an ideal planar surface, of the first phase function and of the second phase function.

the interferential device is in a layout of the Mach-Zehnder type.

the control system comprises an optical projection system able to project a light beam on the reference optical surface and to project a light beam from the phase modification unit onto the optical surface to be measured.

the control system comprises a retractable mirror positioned between the phase modification unit and the projection system.

the optical aberration is without any revolution symmetry.

the optical aberration is a Zernike flaw.

the first optical element and the second optical element are identical.

the first optical element and the second optical element are each selected from a group formed by a plate, a planar-concave lens, a planar-convex lens, a cylindrical lens, a hologram and a mirror.

the phase modification unit includes at least one angular encoder, each angular encoder driving an optical element into rotation.

### BRIEF DESCRIPTION OF THE DRAWINGS

Other features and advantages of the invention will become apparent upon reading the description which follows, of embodiments of the invention, given only as an example and with reference to the drawings wherein:

FIG. 1 is a schematic top view of an exemplary control of an optical surface to be measured, and

FIG. 2 is a schematic view of a phase modification unit for a light beam comprising two rotary optical elements.

### DETAILED DESCRIPTION

In the following, the terms of “upstream” and “downstream” are defined relatively to the direction of the light.

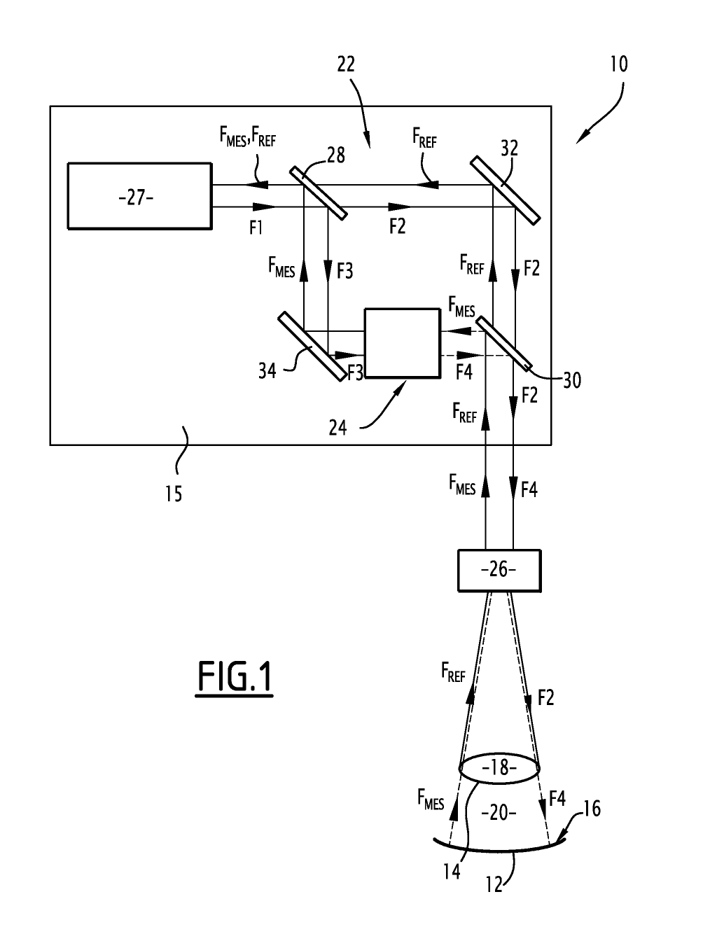

A control system 10 for an optical surface to be measured 12 relatively to a reference optical surface 14 is schematically illustrated by FIG. 1. The control system 10 is based on an optical table 15 having good stability.

The system 10 for controlling an optical surface gives the possibility of carrying out a control of the flatness of the optical surface to be measured 12. This control aims at attaining an accuracy of the order of 10 nm RMS.

The optical surface to be measured 12 is part of optics to be measured 16. The optics to be measured 16 is for example a segment of the primary mirror of a telescope.

The reference optical surface 14 is part of so-called reference optics 18, the reference optical surface of which has a flatness of the same order of magnitude as the measurement accuracy to be attained (here, 10 nm RMS).

The space between the reference optics 18 and the optics to be measured 16 forms an optical cavity 20. The optical cavity 20 represents what is exactly measured by the control system 10. The shorter the optical cavity 20, the better is the stability and the accuracy of the measurement. Notably, inaccuracies may occur because of the temperature gradient of the air crossed in this cavity 20.

The control system 10 comprises an interferential device 22, a unit for modifying the phase 24 of an incident light beam, an optical projection system 26 and a unit 27 used both for generating a laser beam and measuring interference fringes. Depending on the cases, the unit 27 is called a unit for generating a laser beam or a unit for measuring interference fringes.

The interferential device 22 is able to produce interferences between a first light beam having a phase proportional to the deviation between the reference optical surface 14 and an ideal planar surface and a second light beam.

The interferential device 22 is in a layout of the Mach-Zehnder type. This means that the interferential device 22 comprises two beam splitters 28, 30 and two mirrors 32, 34 laid out as to form a rectangle, the diagonals of which are formed by the two beam splitters 28, 30 and the two mirrors 32, 34, respectively.

However, it should be noted that unlike the Mach-Zehnder interferometer, the interference fringes are analyzed after reflection of the beams through the entire interferential device 22 and after having returned to the laser beam generation unit 27.

Each of the two beam splitters 28 and 30 is a plate having planar and parallel faces. However, it is possible, in order to avoid multiple interferences that the planar faces have a non-zero angle between each other.

Further, each of the two beam splitters 28 and 30 is able to play the role of a beam separator and of a means for recombining beams. Beam separators are often designated as “beam splitters”. A beam splitter is able to achieve physical division of a beam, i.e.

separate one beam into two beams. A recombination element is able to recombine two beams so that the two beams form a single beam.

Further, it is advantageous if the beam splitters 28 and 30 ensure a function for equalization of the light intensity between the two split beams and then recombined. For this, the beam splitters 28 and 30 are able to operate for waves polarized according to S or P polarization. In order to generate such a polarization, optionally, the interferential device 22 comprises a polarizer placed upstream from the relevant beam splitter 28.

In the case of FIG. 1, both mirrors 32 and 34 are two planar mirrors.

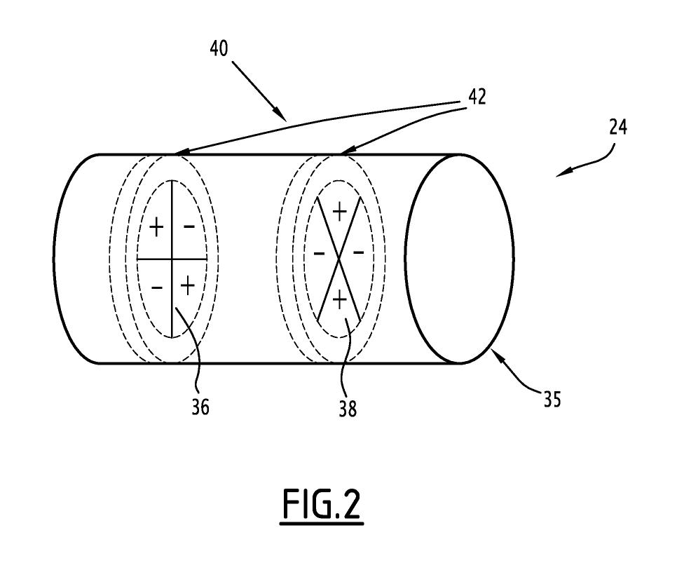

As visible in FIG. 2, the phase modification unit 24 appears as a barrel 35 comprising a first optical element 36, a second optical element 38 and a means 40 for modifying the angle between the two optical elements 36, 38.

The first optical element 36 is provided with a first optical axis O1.

The optical axis is defined for any optical element as the central axis of the contour of an optical element.

The first optical element 36 is able to introduce in transmission a first phase function in the phase of an incident beam.

According to the example of FIG. 1, the first phase function corresponds to an optical aberration without any revolution symmetry.

An optical aberration is a deviation between the actual image and the ideal image of an object through a perfect optical system. More specifically, within the context of the invention, the optical aberration is characterized by the deviation between an ideal wave surface and a wave surface exhibiting aberration. The first phase function is equal to this deviation.

When the actual image does not have any revolution symmetry, the relevant optical aberration is without any revolution symmetry. This is notably the case of astigmatism and coma aberrations.

Preferentially, the optical aberration is a Zernike flaw. By the expression “Zernike flaw” is meant a flaw having a decomposition according to a single monomial on the basis of Zernike polynomials. As an example, the relevant Zernike flaw is astigmatism, coma, trefoil or quadrifoil. As an example, the first phase function corresponds to astigmatism.

In the example of FIG. 1, the first optical element 36 is a plate with parallel faces, one face of which includes an astigmatism flaw. This astigmatism flaw may be generated by traditional or numerical control polishing. It may also be generated by micro-lithography within the scope of CGH (computer generated hologram). In FIG. 2, the flaw is indicated by a cross delimiting four areas, two areas being marked with a “+” in order to indicate the bumps and the two other areas being marked with a “−” in order to indicate the recesses. The areas marked with a “+” diagonally face each other.

Alternatively, both faces include the Zernike flaw.

The first optical element 36 is made in a material used in the field of polishing such as silica or BK7. Alternatively, the first optical element 36 is made in zinc sulfide for generating an aberration of larger amplitude.

Alternatively, the first optical element 36 is a planar-concave or planar-convex lens. The non-planar face is usually the face which bears the Zernike flaw. Further, the presence of a lens in the phase modification unit 24 implies that the convergence or the divergence of the lens should be taken into account in the optical design of the optical projection system 26.

According to an embodiment, instead of a planar-concave or planar-convex lens, a cylindrical lens is considered.

According to still another alternative, the first optical element 36 is a hologram. Preferably, the hologram is generated by a computer.

The second optical element 38 is provided with a second optical axis O2. It is also advantageous, like in the case of FIG. 2, if the first optical axis O1 and the second optical axis O2 coincide.

The second optical element 38 is able to introduce in transmission a second phase function into the phase of an incident beam. According to the example of FIG. 2, the second phase function corresponds to the same optical aberration without any revolution symmetry introduced by the first optical element 36, i.e. an astigmatism flaw.

In the example of FIG. 2, the second optical element 38 is also a plate with parallel faces, one face of which includes the astigmatism flaw.

The other alternatives indicated for the first optical element 36 also apply for the second optical element 38. Preferably, the first optical element 36 and the second optical element 38 are identical.

At least one from among the first optical element 36 and the second optical element 38 is rotary around the optical axis O1, O2 specific to the relevant optical element 36, 38. According to the example of FIG. 2, both the first optical element 36 and the second optical element 38 are rotary.

In the case of FIG. 1, the means 40 for modifying the angle between the two optical elements 36, 38 comprises two angular encoders 42. Each angular encoder 42 is preferably with a hollow axis. Alternatively, the angular encoder is a wheel driving the optical element by contact on the edge of the optical element.

Preferably, in order to obtain accurate control of the angular shift between the optical elements, the means 40 for modifying the angle between both optical elements 36, 38 is an optical encoder.

The optical projection system 26 is an optical system comprising several lenses in a barrel having adjustable spacers between the lenses. The lenses are symmetrical with spherical or aspherical optical surfaces. As an example, the lenses are made in a material used in the field of polishing such as silica or BK7.

Alternatively, the optical projection system 26 includes a set of mirrors or a set of lenses and mirrors.

The optical projection system 26 is able to achieve adaptation of the wave surface associated with the wave comprising the optical aberration introduced by the modification unit 24, to the optical surface to be measured 12 of the optics to be measured 16.

The optical projection system 26 is able to achieve adaptation of the wave surface associated with a beam generated by the generation unit 27, to the optical reference surface 14.

Thus, the optical projection system 26 gives the possibility of reliably projecting the optical aberration generated upstream onto the optics to be measured 16, which amounts to minimizing the distortion in the plane of the optics to be measured 16. Further, the optical projection system 26 gives the possibility of adapting the convergence or divergence of the beam so as to correspond to the needs of the interferometric measurement. This amounts to making the aperture upstream from the optical projection system 26 adapted to the numerical aperture of the optics to be measured 16.

This has the consequence that the optical design of the optical projection system 26, i.e. the selection of the optics and of their positioning, is all the more complex since the amplitude of the optical aberration introduced by the modification unit 24 is strong, since the optics to be measured 16 has a strong numerical aperture and the ratio between the size of the optics to be measured 16 and the size of the two optical elements 36, 38 is high.

The generation unit 27 is able to generate a laser beam preferentially having a divergence of less than 10 milliradians (mrad).

The unit for generating a laser beam 27 is most often a gas laser of the helium-neon type emitting at 632.8 nm. This unit 27 may also be a laser diode.

The operation of the control system 10 of FIG. 1 is now described with reference to two distinct actions: calibration of both optical elements 36, 38 and use of the control system 10 for conducting a measurement of the interferometric type.

The optical elements 36, 38 are calibrated by making the introduced aberration amplitude zero in order to calibrate both optical elements 36, 38.

For this, both optical elements 36 and 38 are set to be in phase opposition, so as not to modify the phase at the output of both of these optical elements 36 and 38. It is then possible to carry out calibration for example by using a retractable planar mirror positioned between the phase modification unit 24 and the optical projection system 26. The calibration is then completed by a measurement of the introduced aberration by performing a small angular position deviation which allows the introduced aberration to remain measurable when compared with an ideal wave.

The use of the control system 10 for conducting a measurement of the interferometric type is now described.

The unit 27 for generating a laser beam emits a first light beam F1. This first light beam F1 is a collimated laser beam.

The first beam F1 propagates as far as the first beam splitter 28. At this first beam splitter 28, the first beam F1 is divided into two beams, a second beam F2 and a third beam F3.

The second beam F2 is led as far as the optical projection system 26 via the first mirror 32 and the second beam splitter 30.

The third beam F3 propagates as far as the phase modification unit 24 by being reflected by the second mirror 34. In the phase modification unit 24, the third beam F3 successively passes through the following faces: the planar face of the first optical element 36, the deformed face of the first optical element 36 comprising an astigmatism aberration, the deformed face of the second optical element 38 comprising an astigmatism aberration and the planar face of the second optical element 38. This allows introduction of a phase function into the phase of the third beam F3 corresponding to an optical aberration without any revolution symmetry, in the case here, an astigmatism aberration. The introduced optical aberration is the theoretical majority aberration of the optics to be measured 16. In this case for an off-axis mirror, this majority aberration is often astigmatism.

A fourth beam F4 is thus obtained at the output of the phase modification unit 24. The fourth beam F4 is reflected by the second beam splitter 30 and propagates as far as the optical projection system 26.

The second beam F2 and the fourth beam F4 are respectively projected on the reference surface 14 and on the surface to be measured 12 of the optics to be measured 16.

The beam reflected by the reference surface 14 includes a phase proportional to the deviation between the optical surface to be measured and an ideal planar surface. The reflected beam is therefore a reference beam noted as F_{REF}.

The beam reflected by the surface to be measured 12 includes a phase proportional to the deviation between the optical surface to be measured and an ideal planar surface to which the optical aberration without any revolution symmetry introduced by the phase modification unit 24 has been added. The reflected beam is therefore a measurement beam noted as F_{MES}.

The reference beam F_{REF} then follows the following path: transmission through the second beam splitter 30, reflection by the first mirror 32 and transmission through the first beam splitter 28. The measurement beam F_{MES} then follows the following path: reflection by the second beam splitter 30, reflection by the second mirror 34 and reflection by the first beam splitter 28. Moreover, it should be noted that this trajectory is more efficient if the second beam splitter 30 is treated, like the first beam splitter 28, so as to reflect a certain polarization (S polarization) and to transmit the other (P polarization).

After the first beam splitter 28, interferences between the reference F_{REF} and measurement F_{MES} beams are observable, which gives the possibility of tracing back the deviation of the wave-front between both beams by either varying the wavelength of the incident beam or a mechanical position of an optical element such as the optics 12 to be measured.

In the case of deviation between the optical aberration without any revolution symmetry which it is assumed to have and the optical aberration really exhibited by the surface to be measured 16, the angular deviation between both optical elements 36, 38 is modified in order to better compensate for the optical aberration without any revolution symmetry which exhibits the surface to be measured 16.

Thus, applied to an off-axis mirror segment, the proposed method provides compensation for the astigmatism of the latter. The astigmatism aberration of such a mirror may be of the order of 200 microns which prevents the carrying out of an interferometric control on the quality of the surface such as a mirror. By compensating for the astigmatism aberration, it is possible to access other aberrations of more reduced amplitude, such as coma, for which interferometric control is possible. The proposed system thus gives the possibility of achieving the control of the surface to be measured 12 of optics to be measured 16. In this case, however, when the other more reduced amplitude aberrations remain significant, it is also possible to add an additional modification unit 24, the purpose of which would be to compensate for this other aberration, for example coma.

Further this gives the possibility of replacing a set of test optics, such as holograms, with a single combination of optics. More specifically, instead of having one hologram per segment type, the control system 10 gives the possibility of associating a position of the two optical elements 36, 38 to each segment type. In other words, the same pair of optical elements 36, 38 compensates for the main geometrical aberration of the optics to be measured 16 for a range of different values of this geometrical aberration, which solves the adaptability of this control system to different values of geometrical aberration.

This makes the control system 10 adaptable to the optical surface to be measured 12 depending on the respective angular position of both optical elements 36, 38. Instead of making several tens of holograms and controlling them for controlling the segments in the state of the art, the few optics of the control system 10 are sufficient for ensuring the same function. This causes lowering of the cost associated with carrying out a control of a set of optical surfaces to be measured 12.

The control system 10 also gives the possibility of increasing the accuracy and the reliability of the measurement. Indeed, the control system 10 is not very sensitive to vibrations. Further, it is possible to calibrate the elements used even once they are positioned, for example by means of a planar mirror upstream from the projection system. The calibration around the zero value of the phase modification unit 24 allows good quality calibration of the introduced aberration depending on the angle between both optical elements 36, 38.

Improvement of the quality also stems from the fact that the dependency on external parameters for the measurements is made as small as possible. As an example, the relevant cavity 20 is short (the reference surface and the surface to be measured are close) in order to decrease the effects of temperature and the optical cavity 20 may not be displaced mechanically. Indeed, it is possible not to use diffractive elements on the expected control configuration, unlike the state of the art. An optical displacement is sufficient.

Further, the control system 10 is not very sensitive to misalignments or possible off-centering of the optical elements 36, 38, according to simulations carried out by the applicant.

The proposed control system 10 further gives the possibility of obtaining very low distortion and of not obturating the reference F_{REF} and measurement F_{MES} beams.

The proposed control system 10 is particularly suitable for off-axis surfaces and thus having a theoretical surface described by terms such as astigmatism and coma terms. However, the control system 10 adapts to any other theoretical surface, and notably those which are often encountered in the field of astronomy and space science.

Alternatively, both optical elements do not operate in transmission like in the case of FIG. 1 but in reflection. As an example, both optical elements 36, 38 are off-axis mirrors.

The different embodiments of the control system 10 may notably be used in the field of astronomy. Notably, this control system 10 is of particular interest for a range of optical elements having variable optical aberration such as for example mirrors with a paraboloidal shape located off-axis. This control system 10 by extension applies to any fields in which accurately polished optics are used such as space science (observation of the earth and astronomy notably), defense or the environment.

Further, in all the cases, the control system 10 of the optical surface to be measured 12 relatively to the reference optical surface 14 allows accurate control of several optics of a different type while retaining some convenience in use.

What is claimed is:

1. A control system for controlling an optical surface to be measured relatively to a reference optical surface, the control system comprising:
an interferential device in a Mach-Zehnder layout with two beam splitters and comprising a unit for modifying the phase of an incident light beam, the phase modification unit being placed between both beam splitters and comprising:
a first optical element provided with a first optical axis and able to introduce a first phase function into the phase of an incident beam, and
a second optical element provided with a second optical axis and able to introduce a second phase function into the phase of a beam transmitted or reflected by the first optical element, the first phase function and the second phase function each corresponding to the same optical aberration and at least one from among the first optical element and the second optical element being rotary around the optical axis specific to the relevant first or second optical element.

2. The control system according to claim 1 wherein the interferential device is between a first light beam and a second light beam, the first beam having a phase proportional to the deviation between the optical reference surface and an ideal planar surface and the second beam having a phase equal to the sum of a phase proportional to the deviation between the optical surface to be measured and an ideal planar surface, of the first phase function and of the second phase function.

3. The control system as recited in claim 1 further comprising an optical projection system able to project a light beam on the optical reference surface and of projecting a light beam from the phase modification unit onto the optical surface to be measured.

4. The control system as recited in claim 3 further comprising a retractable mirror positioned between the phase modification unit and the projection system.

5. The control system as recited in claim 1 wherein the optical aberration is without any revolution symmetry.

6. The control system as recited in claim 1 wherein the optical aberration is a Zernike flaw.

7. The control system as recited in claim 1 wherein the first optical element and the second optical element are identical.

8. The control system as recited in claim 1 wherein the first optical element and the second optical element are each selected from a group consisting of a plate, a planar-concave lens, a planar-convex lens, a cylindrical lens, a hologram and a mirror.

9. The control system as recited in claim 1 wherein the phase modification unit includes at least one angular encoder, each angular encoder driving an optical element into rotation.
